(19) United States
(12) Patent Application Publication
(10) Pub. No.: US 2008/0154896 A1
(43) Pub. Date: Jun. 26, 2008

(54) PROCESSING UNSTRUCTURED INFORMATION

(75) Inventors: Yathish Sarathy, Fremont, CA (US); Ralph Jacob Cressman, San Francisco, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc., San Jose, CA (US)

(21) Appl. No.: 11/941,349

(22) Filed: Nov. 16, 2007

Related U.S. Application Data
(60) Provisional application No. 60/866,378, filed on Nov. 17, 2006.
(60) Provisional application No. 60/866,573, filed on Nov. 20, 2006.

(51) Int. Cl. G06F 7/10; G06F 17/30

(52) U.S. Cl. 707/6; 707/5; 707/E17.014

(57) ABSTRACT

Apparatus, systems, and methods may operate to examine a quantity of language-based communication to determine a plurality of topics associated with the quantity, and to determine whether a number of the plurality of topics converge to a selected degree. Responsive to determining convergence to the selected degree, ranking selected topics in the plurality of topics according to relevance may occur. Additional apparatus, system, and methods are disclosed.

### CLAIM OF PRIORITY

The present patent application claims the priority benefit of the filing date of U.S. provisional application No. 60/866,573 filed Nov. 20, 2006, and to U.S. provisional application No. 60/866,378 filed Nov. 17, 2006, which applications are incorporated in their entirety herein by reference and made a part hereof.

### BACKGROUND

The ubiquitous presence of networked computers, and the growing use of databases, web logs, and email has resulted in the accumulation of vast quantities of information. Many individual computer users now have access to this information via search engines and a bewildering array of web sites.

As more tasks become automated, a similar proliferation of stored and easily accessible information has made its appearance in business operations. The combined total volume of information that can be accessed on most networks thus raises issues even when the relatively minor task of searching for documents within the context of a single enterprise, let alone across the Internet. Such issues include how effectively the search can penetrate the information searched, and whether the ultimate result will be sufficiently relevant. Therefore, managing access to the information available to computer users at any particular time creates a number of challenges and complexities.

### BRIEF DESCRIPTION OF THE DRAWINGS

The present disclosure is illustrated by way of example and not limitation in the figures of the accompanying drawings, in which:

FIG. 1 is a graph illustrating the convergence of noun/object conjugations in a sample of unstructured information according to various embodiments of the invention.

FIG. 2 is a simplified diagram of a graphical user interface to process unstructured information according to various embodiments of the invention.

FIG. 3 is a diagram illustrating a process of augmenting machine-generated information according to various embodiments of the invention.

FIG. 4 is a block diagram of apparatus and systems according to various embodiments of the invention.

FIG. 5 is a flow diagram illustrating methods according to various embodiments of the invention.

FIG. 6 is a block diagram illustrating applications that can be used to access and process unstructured information according to various embodiments of the invention.

FIG. 7 is a block diagram illustrating a client-server architecture to facilitate access to unstructured information according to various embodiments of the invention.

FIG. 8 is a block diagram of a machine in the example form of a computer system according to various embodiments of the invention.

### DETAILED DESCRIPTION

### Introduction

Much of the information available to computer users comprises unstructured information in the form of language-based communication. For the purposes of this document, “language-based communication” is any communication between humans based on language, whether delivered visually, by touch, or by sound (e.g., documents, emails, icons, photographs, Braille impressions, live and recorded conversations, etc.).

For example, most enterprise documents comprise language-based communication, and typically take on a variety of formats. Enterprise users often have tight schedules, and so expect to spend little time searching through this type of information; when a search is conducted, they expect to obtain highly relevant results. Traditional text indexing, as may be used with simple keyword matching, typically penetrates the content of unstructured information in only one-dimension, rendering less than acceptable results.

Searching techniques available in public, non-enterprise contexts (e.g., the Internet) are also less than adequate in many situations, since the collections of documents available are usually not heavily cross-linked. For example, page-ranking solutions are not very effective due to the sparse prevalence of anchor tag linkages (e.g., as used in hypertext markup language (HTML) documents).

Some of the embodiments described herein seek to address these challenges and others presented by large quantifies of unstructured data with the use of extraction models to generate topical attributes, augmented by user-generated data (e.g., recommendations, tagging) and user behavior data (e.g., click counts, documents viewed). This may be accomplished in the context of a user's profile, leveraging the collective wisdom of a community of users in a context local to that community (e.g., a wildlife special interest group, or a particular enterprise focused on the distribution of parts).

### Example Operations

Extraction models, in some embodiments, define rules for examining, extracting, and validating topical attribute sets for a given group of unstructured data, including language-based communication data. The defining characteristics of the model may include a generalized extraction mechanism (e.g., semantic parsing), probabilistic sampling distributions for establishing confidence intervals, examining function limits and inflexion curves to determine data convergence, and histogram-based decision filters coupled with a selective cutoff thresholds (e.g., selecting a standard deviation of ±20%) for normally distributed samples.

Semantic parsing techniques (e.g., examining the constituent grammar structure of unstructured data samples) can be used as an extraction mechanism to permit generalized examination of any category of unstructured data, with the benefit of providing an intrinsic boundary—a selected logical grouping of topics, perhaps arranged or ranked in order of occurrence. This result may be applied across a wide-variety of problem spaces.

Language-based communication data lends itself to this process because it has been determined via experimentation that humans interacting within the confines of many contexts (e.g., those having relatively narrow and exclusive content) tend to communicate using parts of words, words, phrases, and symbols that lie within a finite boundary. These “topics,” which may include any type of visual, aural, or tactile linguistic token, can be used to describe such communication, perhaps using additional or alternative topical constructs, including synonyms, acronyms, idioms, etc. Boundaries can be further refined using additional limiting factors such as time (e.g., communications in a business context need to happen quickly), specific intent (e.g., problems need to get solved effectively and quickly, requiring use of commonly recognized and understood patterns of speech) and the likely normal distribution of word construct grammatical merit given a large sample of typical communication data (such that a well-bounded limit on the vocabulary of verbs and objects arises).

A combination of intuitive and experimental analytical techniques has resulted in the discovery of various ways to establish the boundaries of a particular quantity of communication data, including language-based communication data. For example, in some embodiments, given a sample of N unstructured data sets (e.g., N email messages), the process may begin by examining an initial subset of A data sets, such that A is >=32. The A data sets are first analyzed semantically to break down word-patterns, and the frequency histogram of the pattern occurrences are used to extract an initial set of faceted data, or topics. For example, the topics that fall within ±20% of the standard deviation over all topics found in the data may be selected.

Further samples of the remaining N-A data sets can be taken in statistical measures of 32 data set groups, so that additional semantic patterns can be extracted, as already described. The results of examining the remaining sets can be plotted along with those from the first A data sets.

In some embodiments, the incremental plot of results from all the statistical data sets are examined to determine function limits, inflexion points, and convergence. Projected convergence at a future (theoretical) limit of data points may also be considered.

If convergence to some selected degree is obtained, the function characteristics that determine accept/reject scenarios may be elaborated separately to comprise attributes of the underlying data groups. For example, sampled groups of data may might exhibit unique function characteristics (e.g., ranking of topics) that are assigned as a “signature” for that group. Such signatures may be stored, and used for comparison with the signatures of other communication data to determine whether substantial similarity, or a match, exists. If so, then a variety of responsive actions may be taken.

For example, consider that a computer may be programmed to examine known sets of unstructured data, such as incoming customer support email messages. Such messages may be associated with a known class or group of support issues (e.g., updating profile contact information). After parsing, a set of noun/object conjugations might be observed to display rapid convergence to some desired degree within a relatively small set of messages (e.g., less than 100 messages). Even when the sample size is reduced to ten messages, so that messages are examined in groups of ten, no substantial loss of convergence may be observed. The typical results of this type of analysis are shown in Table I:

TABLE I
Group Category: Updating Your Contact Information

| | 30 Total Email | 40 Total Email | 50 Total Email |
|---|---|---|---|
| | Messages | Messages | Messages |
| | (First Sample) | (Next Sample) | (Last Sample) |
| New Verbs | 15 | 3 | 2 |
| Identified | | | |
| New Objects | 11 | 2 | 1 |
| Identified | | | |
| Topic Not | 4 | 0 | 1 |
| Identifiable | | | |

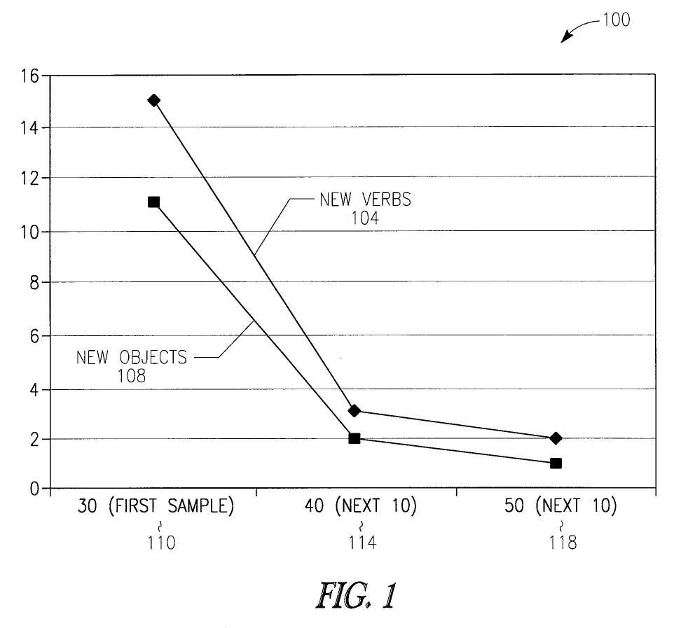

FIG. 1 is a graph 100 illustrating the convergence of noun/object conjugations in a sample of unstructured information according to various embodiments of the invention. Here the data of Table I are shown in graphic form, and organized according to the number of messages analyzed.

The upper curve illustrates the number of new verbs found 104 in the group of messages for the first sample 110 of thirty messages, the second sample 114 of ten more messages, and the third sample 118 of ten more messages, or fifty messages altogether. The lower curve illustrates the number of new objects found 108 in the group of messages for the same first sample 110 of thirty messages, the same second sample 114 of ten more messages, and the same third sample 118 of ten more messages.

The degree of topical convergence for such a group of language-based communication (e.g., customer support emails) might be specified as finding less than five new verbs and five new objects in the final group of ten messages after examining fifty total messages. In more refined embodiments, the degree of topical convergence for the group of fifty messages might even be identified as finding less than three new verbs and two new objects in the final group of ten messages that are examined. Either set of convergence criteria would be satisfied by the data shown in Table I and the graph of FIG. 1. Of course, other sample group sizes, and other degrees of convergence may be specified, as described below.

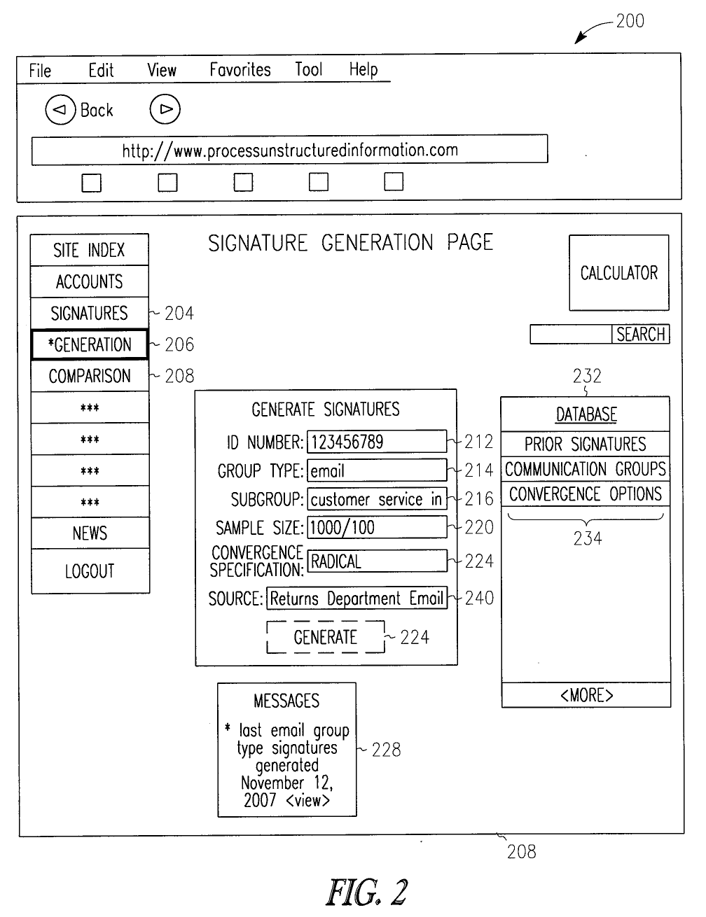

FIG. 2 is a simplified diagram of a graphical user interface 200 to process unstructured information according to various embodiments of the invention. This interface 200 is one of many that are possible. In the particular example of FIG. 2, a sample web page that might be seen by an individual user that has logged into their employer site on the Internet.

Here, the “GENERATION” menu option 206 under the “SIGNATURE” menu option 204 has been selected, calling up the SIGNATURE GENERATION PAGE 208. This selection permits the user to specify an identification number 212 that can be associated with a signature for a quantity of data, such as a set of language-based communication.

Here it can be seen that several fields, such as a group type field 216 (e.g., email), a subgroup field 220 (e.g., incoming customer service), a sample size field 220 (e.g., 1000 email messages), a convergence specification field 224 (e.g., RADICAL), and a source field 240 (e.g., Returns Department Emails) may be populated with various information.

The selection entries shown in this instance, for example, might represent what a user would specify for generating a signature to associate with a quantity of 1000 Returns Department email messages. The resulting signature might be identified with the number “123456789”, and linked to a group/subgroup of “incoming customer service email messages”. The group/subgroup may, in turn, result in a choice of several convergence specifications. Choosing the “RADICAL” convergence option might mean that a highly-refined (e.g., rapid) convergence is desired, using a total sample of 1000 emails, and a convergence sample size of 100 emails.

Once the interface 200 entries have been made, the user might click on the GENERATE widget 224 to generate a signature associated with the selected email sample. Once the signature has been generated, the ID number field 212 may then be set so as to no longer permit the entry of the value “123456789”, since this value is now associated with a generated signature, and the widget 224 may now indicate “COMPLETE” (not shown) at that time, for example.

In some embodiments, a message field 228 in the GUI 200 may be used to inform the user when the last signature was generated. The DATABASE menu 232 may include several options 234 that can be used to select specific entries for the fields 214, 216, 220, 224, and 240. Other fields in the GUI 200 may be used to provide additional selection alternatives. Other embodiments may be realized to improve signature-based search performance.

For example, data associated with users themselves may be used to augment the machine-generated data (e.g., topics found in quantities of language-based communication, and resulting signatures) to provide enhanced relevancy from search results. Such enhancements may lend themselves to social searching in the context of an enterprise, for example.

Thus, user-associated data, including user-descriptive data (e.g., user profile data, sub-group membership, company roles, etc.), passive user-generated data, such as that obtained from individual/group user behavior (e.g., number of page views, tracking page flows, etc.), and active user-generated data (e.g., ratings, recommendations, tagging, etc.), can be used to generate a comprehensive relevancy model that helps inform the ordering of search results obtained using the basic examination-convergence model. Therefore, in some embodiments, users can actively add value to their search context by adding meta-data, such as ratings, recommendations and tags to individual items that form a part of larger data sets. Such meta-data may be shared in the context of a user's profile and may be readily available for others within the same profile (e.g., a single work group context).

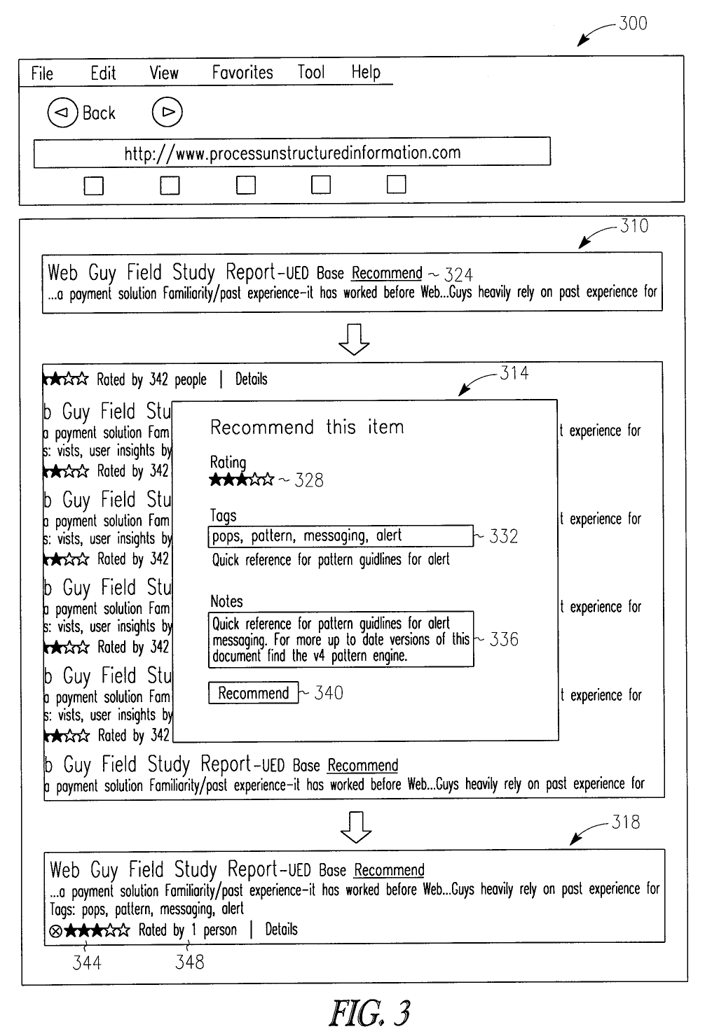

For example, FIG. 3 is a diagram illustrating a process 300 of augmenting machine-generated information according to various embodiments of the invention. This process 300 is one of many that are possible. In the particular example of FIG. 3, a sample of what might be seen by a user that has logged into a meta-data augmentation web page on the Internet is shown.

In the first part of the process 300, a single, original item 310 of language-based communication (e.g., a field study document) is shown. In this part of the process 300, the user has elected to augment the item 310 with user-associated data by activating the link 324.

In the second part of the process 300, a user-associated data entry form 314 may appear, which permits the association of a rating 328, tags 332, and notes 336 with the item 310. After entering the desired user-associated data, the user may activate the Recommend widget 340.

In the third part of the process 300, the augmented item 318 is shown. Here the user-associated data 344 is summarized below the item 318, as a set of tags (e.g., pops, pattern, messaging, alert), a rating (e.g., three stars out of five), and the number of persons (e.g., one) that have rated the original item 310.

The process 300 permits the use of many pre-existing meta-structures that form portions of enterprise databases to be used in enhanced evaluation of the context in which a user submits a system search query. A few examples of such structures include organizational charts and profile rules information (e.g., the type and extent of systems/documents that can be accessed by users/members belonging to a given profile). Such structural user-associated data can be supplemented with passive user-generated data that is obtained in specific types of interactions or sessions, and tracked, for example, starting with a user-initiated search query. Subsequent tracking may include links that are selected, documents tagged, and documents recommended. All of this data may be aggregated at a group level (e.g., sales department), preserving the anonymity of a single users while yielding a powerful set of augmented data that can be used to refine the results obtained in response to future queries. Further augmentation with an attribute extraction schema can be used to permit multi-dimensional traversal of search data.

### Example Apparatus and Systems

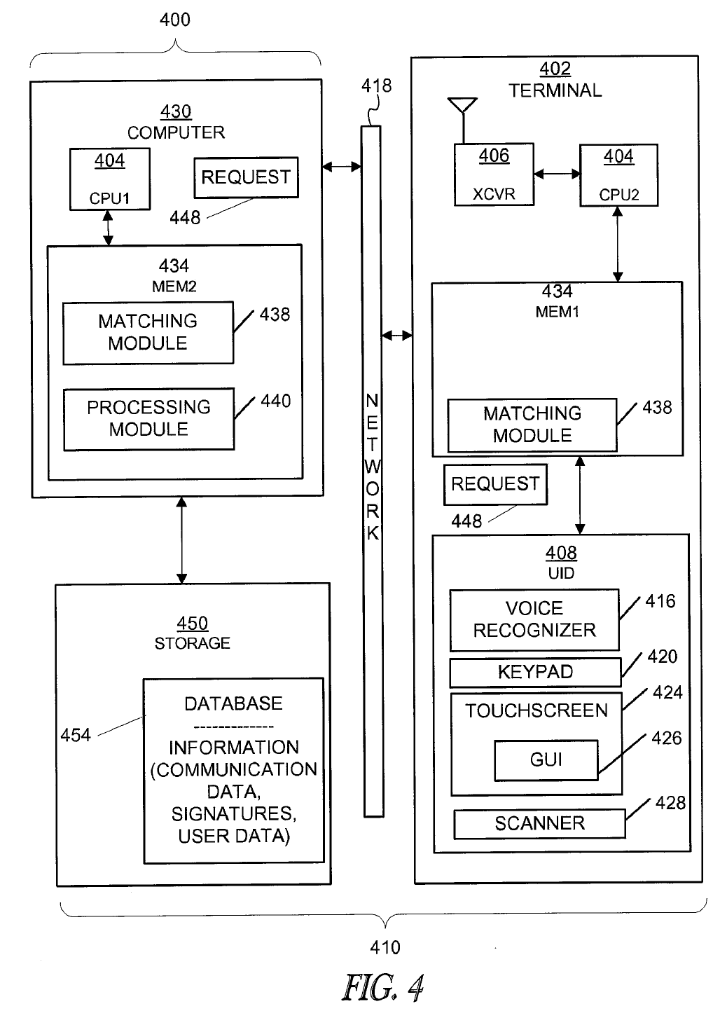

FIG. 4 is a block diagram of apparatus 400 and systems 410 according to various embodiments of the invention. The apparatus 400 may comprise many devices, such as a server, a generic computer 430, or other devices with computational capability.

The apparatus 400 may include one or more processors 404 coupled to a memory 434. Requests 448, such as search requests and other user-supplied information, including language-based communication (e.g., email messages) may be received by the apparatus 400 and stored in the memory 434, and/or processed by a combination of the processor 404, the matching module 438, and/or the communication processing module 440.

The matching module 438 can be used to determine whether signatures associated with multiple sets of data match. For example, whether a signature stored in the database 454 and derived from a quantity of language-based communication matches the signature associated with an incoming email message forming part of a request 448.

The communication processing module 440 can be used to examine and derive topics from (e.g., parse) unstructured data, such as a quantity of language-based communication. The processing module 440 can also be used to determine whether topics derived from the data converge to some desired degree, to rank topics according to relevance, and to associate a signature with a set of ranked topics.

In some embodiments, the apparatus 400 may comprise a storage device 450 to couple to a computer 430. The storage device 450 may be used to store a database 454 that includes a variety of information, including unstructured information, signatures, user-supplied information, topical ranking, etc.

A system 410 may include one or more of the apparatus 400, and one or more terminals 402. Such terminals 402 may take the form of a desktop computer, a laptop computer, cellular telephone, a point of sale (POS) terminal, and other devices that can be coupled to the apparatus 400 via a network 418. Terminals 402 may include one or more processors 404, and memory 434. The network 418 may comprise a wired network, a wireless network, a local area network (LAN), or a network of larger scope, such as a global computer network (e.g., the Internet). Thus, the terminal 402 may comprise a wireless terminal, with a wireless transceiver 406.

In some embodiments, the terminal 402 may comprise one or more user input devices 408, such as a voice recognition processor 416, a keypad 420, a touchscreen 424, a scanner 426, etc. The touchscreen 424 or other display device may be used to display one or more graphical user interfaces, such as those shown in FIGS. 2 and 3.

Apparatus 400 and terminals 402 may be used to select communication data for signature generation, as shown in FIG. 2. Apparatus 400 and terminals 402 may also operate to receive user-supplied information to augment language-based communication data, as shown in FIG. 3. Requests 448, including search requests, may also be originated at the apparatus 400 and/or the terminals 402. In some embodiments, the apparatus 402 may also comprise a matching module 438.

Thus, many embodiments may be realized. For example, a system 410 may comprise a computer 430 to communicatively couple to a global computer network 418 and a matching module 438 that operates to examine user-supplied information 448 received at the computer 430 and to determine whether an information signature associated with the user-supplied information 448 substantially matches a signature (e.g., stored in the database 454 or memory 434) associated with ranking selected topics according to relevance, wherein the selected topics (perhaps also stored in the database 454) are selected from a plurality of topics associated with a quantity of language-based communication. Prior to determining whether a match exists, it is assumed that some number of the plurality of topics have been determined to converge to a selected degree with respect to the quantity of language-based communication. In some embodiments then, the system 410 may comprise a server with software in memory that can be executed to match signatures based on topical convergence.

The system 410 may also comprise a user terminal 402 to couple to the computer 430. The terminal 402 may be used to present a graphical user interface 426 that can be used, in turn, to receive user-supplied information 448. In some embodiments, the system 410 may comprise one or more storage devices 450 to couple to the computer 430 and to store a database 454 having signatures associated with ranking selected topics for one or more portions of various quantities of language-based communication.

### Example Methods

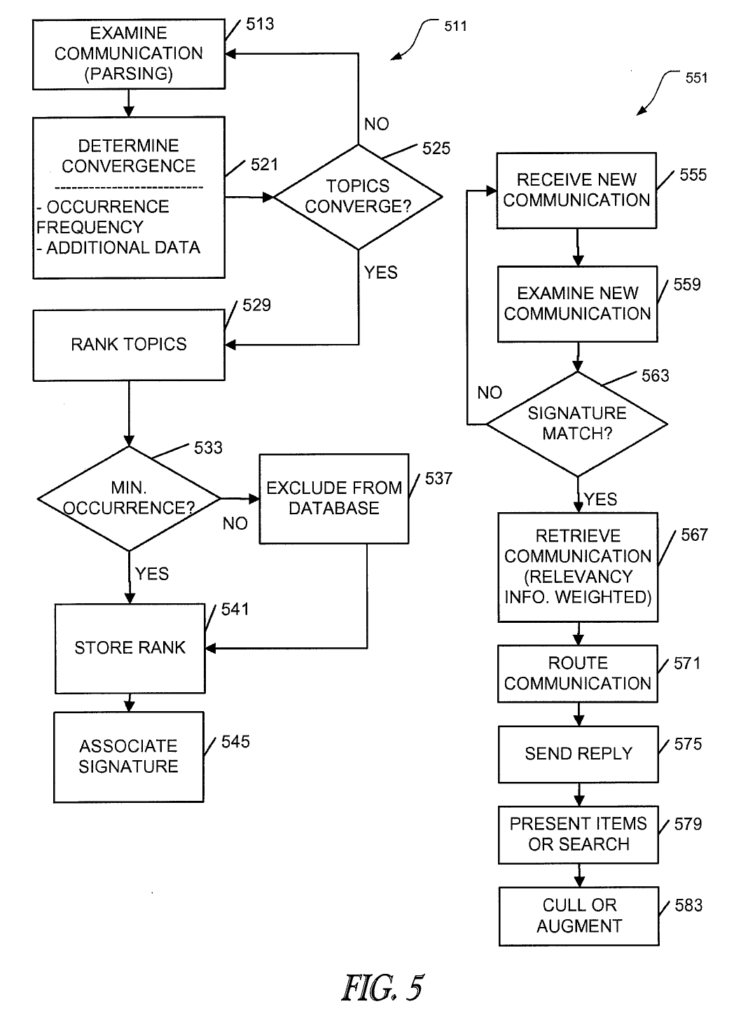

FIG. 5 is a flow diagram illustrating methods 511 according to various embodiments of the invention. For example, a computer-implemented method 511 to rank converging topics extracted from unstructured information may begin at block 513 with examining a quantity of language-based communication to determine a plurality of topics associated with the quantity of communication. For example, the language-based communication may comprise one or more of online auction search queries, email messages, or conversation sound recordings. Topics may comprise word portions, words, phrases, or parts of speech. Thus, examining may comprise, as described previously, parsing the quantity of language-based communication to designate or assign one or more of word portions, words, phrases, or parts of speech as some of the plurality of topics.

The method 511 may continue with determining whether a number of the plurality of topics converge to a selected degree at block 521. Convergence may be determined in a number of ways. For example, in some embodiments, convergence is satisfied by determining that the occurrence frequency of at least one of the plurality of topics satisfies a selected occurrence boundary condition. Such boundary conditions may include the number of new topics found when additional data is examined, the total number of topics that are found, or even how boundary conditions are approached. For example, the selected occurrence boundary condition may be approached by a number of the plurality of topics approximately asymptotically (e.g., see the convergence behavior shown in FIG. 1).

Another way to determine whether the selected degree of convergence has been achieved is to examine another quantity of the language-based communication, and to find that such examination does not increase the occurrence frequency of at least one of the plurality of topics (from the original quantity of communication data) beyond a selected maximum occurrence frequency increment. That is, by finding that the frequency of topics found in new communication data doesn't substantially change with respect to the frequency of topics determined within a set of previously-examined communication data.

Determining whether a number of the plurality of topics converge to a desired degree may also comprise examining an additional quantity of language-based communication to determine additional topics (e.g., as shown in Table I), and then determining that an occurrence frequency associated with the additional topics is less than a selected maximum occurrence frequency (as described in the examples related to Table I).

If a sufficient degree of convergence is not found to exist at block 525, then the method 511 may continue on to block 513. If sufficient convergence is found at block 525, then the method 511 may continue on to block 529. Thus, responsive to determining that the number of the plurality of topics converge to the selected degree at block 525, the method 511 may include ranking selected topics in the plurality of topics according to relevance at block 529.

In some embodiments, the method 511 may continue on to block 533 with determining that at least one of the plurality of topics occurs with an occurrence frequency greater than a selected minimum frequency of occurrence. For example, topics that have a frequency of occurrence within ±20% of a standard distribution may be separated from those that fall outside of that range. Or topics that are found in at least 80% of examined emails in a group might be separated from those that do not.

If the topics that are determined to exist within a quantity of language-based communication do not occur with the designated frequency, as determined at block 533, then the method 511 may include excluding those topics from storage in a ranking and/or signature database at block 537, for example. As another example, if it is determined that certain topics do not occur at least X times in Y quantity of data, then those topics may be excluded from forming part of the rank-based signature associated with a particular quantity of language-based communication.

Whether or not the topics determined to exist via examination do meet a selected minimum frequency of occurrence, the method 511 may go on to include, at block 541, storing the ranking of selected topics as a topical signature. Storing at block 541 may include storing one or more signatures in the database for later access. That is, there can be multiple signatures associated with the examined data (e.g., each having different convergence criteria), and these may be stored in the database for use in a variety of matching activities.

The method may further include associating the topical signature with the quantity of language-based communication at block 545. Thus, the set of topics, the ranking of topics, and/or the convergence behavior of topics may comprise a topical signature. Other embodiments may be realized.

For example, some computer-implemented methods 551 of processing unstructured information include receiving a new set of communication data, such as a quantity of language-based communication, at block 555. The quantity may be relatively small (a single search query, or one email message), or relatively large (a thousand email messages, or thousands of search queries). Thus, the method 551 may even include receiving communication (e.g., a query) at block 555 that includes a request to search a quantity of language-based communication that has previously been examined at block 513.

The new set of communication data may then be examined at block 559, in a similar fashion to that which occurs at block 513. Thus, the method 551 may include examining an incoming email message to determine a message signature associated with topics included in the incoming email message. In some embodiments, the method 551 may include examining an incoming search query to determine a query signature associated with topics included in the incoming query.

The method 551 may go on to block 563 to determine that the new quantity of language-based communication has a new signature substantially matching the topical signature derived from a prior quantity of language-based communication. If the signatures are not found to match (e.g., the number, type, and/or content of topics are not at least 70%, or 80%, or 90% in agreement, or in agreement to some other pre-selected level), then the method 551 may include going on to block 555 to receive additional communication.

In some embodiments, matching is determined by examining a second quantity of language-based communication to determine whether the number of topics associated with the second quantity of communication converges to a substantially similar degree as that of the original set of data. Thus, signature matching may also be determined by comparing the degree to which two sets of data converge, or by comparing their convergence patterns, perhaps as various sampling intervals are used.

If two sets of data are found to match via meeting the same convergence criteria, and/or by their convergence patterns, then the method 551 may include linking user-generated relevancy information associated with an original quantity of language-based communication to the second quantity of language-based information. Thus, new information that has a convergence profile similar to information that has already been examined and augmented by user-generated relevancy information can now be linked to previously-existing user-generated relevancy information, providing a richer set of new data.

If a match is found at block 563, then the method 551 may include a number of activities, depending on the particular application. For example, the method 551 may include at block 567 retrieving some of the quantity of language-based communication based on the topical signature. That is, some of the previously-examined communication data (perhaps examined at block 513) may be retrieved based on matching its signature to that of newly-examined data at block 563. In this way, topics found in new data (e.g., a single search query, a single email, etc.) can be used to retrieve relevant older data based on previously-established signatures. Thus, the method 551 may include at block 567 retrieving a portion of the original quantity of communication based on a query signature associated with a query, wherein the query signature substantially matches a topic signature associated with the ranking of selected topics (that have been determined to exist in the original data).

Retrieval at block 567 may include receiving user-generated relevancy information (e.g., augmentation data, as described with respect to FIG. 3) associated with the quantity of language-based communication. The user-generated relevancy information may comprise one or more of a rating, a tag, a hyperlink, a pre-defined item category, a sales price range, a brand, a role, a group (e.g., a department, a team, gender, ethnicity, age range), a portion of a user profile, a salary range, a name (an employee name, a friend's name), or a comment, among others. In certain embodiments, the method 551 may include weighting retrieval of additional information based on the ranking of selected topics according to the user-generated relevancy information. Thus, user-generated relevancy information can be used as a weighting factor for retrieving older information, perhaps with those items that have more user-generated input (a higher cross-link value) receiving priority.

In some embodiments, the method 551 may include routing an incoming email message at block 571 to a destination associated with the ranking of selected topics associated with a topic signature that substantially matches the message signature (associated with the incoming email message). This embodiment enables automated email routing using matching signatures.

The method 551 may also include sending a reply email message at block 575 to an address associated with an incoming email message, wherein the content of the reply email message is based on the topic signature that has been matched. This embodiment enables automated email replies based on signature matching.

The method 551 may include, at block 579, presenting one or more of a group of online auction items based on a topic signature substantially matching a query signature associated with ranking of selected topics for a quantity of language-based communication comprising online auction description information. Alternatively, or in addition, the method 511 may include presenting one or more alternate searches based on a topic signature substantially matching a query signature associated with ranking of selected topics for a quantity of language-based communication comprising search entries. Thus, various embodiments may enable automated item or search filter presentation based on signature matching

In some embodiments, the method 551 may include, at block 583, the use of user-generated relevancy information to either cull some portion of the original quantity of language-based communication, or to retrieve an additional portion of the original language-based communication. It is assumed in this case that the user-generated relevancy information has been previously associated with the quantity of language-based information that is being processed. Thus, user-generated relevancy information can be used to filter or augment the amount of content produced by implementing the machine-generated relevancy techniques disclosed herein.

The methods 511, 551 described herein do not have to be executed in the order described, or in any particular order. Moreover, various activities described with respect to the methods identified herein can be executed in repetitive, serial, or parallel fashion. Information, including parameters, commands, operands, and other data, can be sent and received in the form of one or more carrier waves.

One of ordinary skill in the art will understand the manner in which a software program can be launched from a computer-readable medium in a computer-based system to execute the functions defined in the software program. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or interprocess communication techniques, including remote procedure calls. The teachings of various embodiments are not limited to any particular programming language or environment.

Thus, the methods described herein may be performed by processing logic that comprises hardware (e.g., dedicated logic, programmable logic), firmware (e.g., microcode, etc.), software (e.g., algorithmic or relational programs run on a general purpose computer system or a dedicated machine), or any combination of the above. It should be noted that the processing logic may reside in any of the modules described herein.

Therefore, other embodiments may be realized, including a machine-readable medium (e.g., the memories 434 of FIG. 4) encoded with instructions for directing a machine to perform operations comprising any of the methods described herein. For example, some embodiments may include a machine-readable medium encoded with instructions for directing a server or client terminal or server to perform a variety of operations. Such operations may include any of the activities presented in conjunction with the methods 511, 551 described above. Various embodiments may specifically include a machine-readable medium comprising instructions, which when executed by one or more processors, cause the one or more processors to perform any of the activities recited by such methods.

### Marketplace Applications

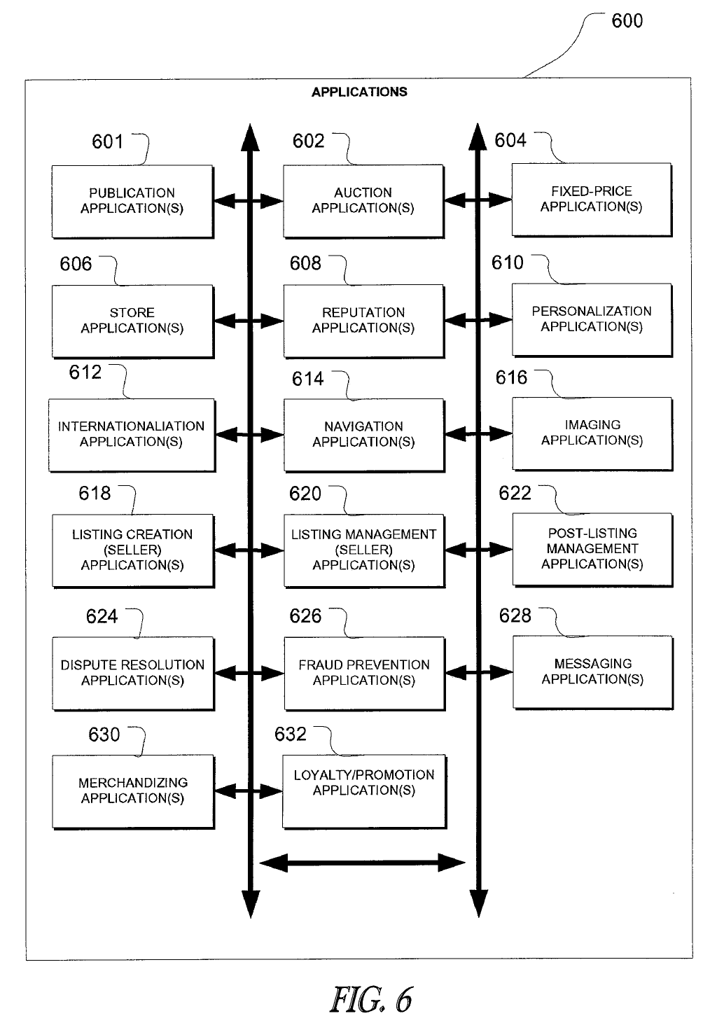

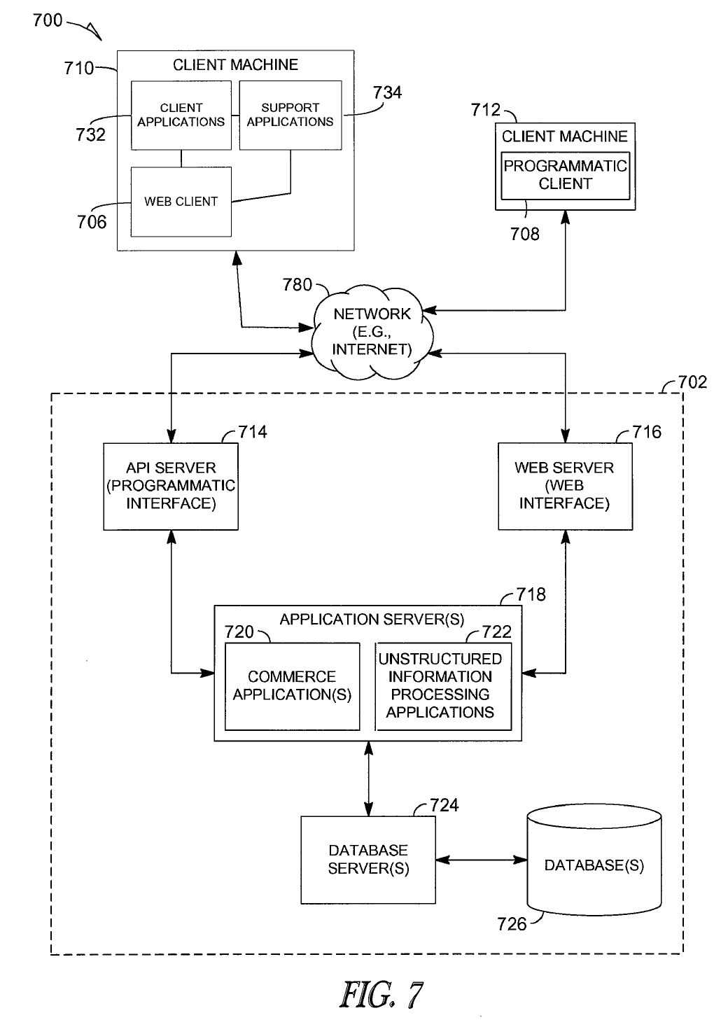

FIG. 6 is a block diagram illustrating applications 600 that can be used to access and process unstructured information according to various embodiments of the invention. These applications 600 can be provided as part of a networked system, including the systems 410 and 700 of FIGS. 4 and 7, respectively. The applications 600 may be hosted on dedicated or shared server machines that are communicatively coupled to enable communications between server machines. Thus, for example, any one or more of the applications may be stored in memories 434 of the system 410, and/or executed by the processors 404, as shown in FIG. 4.

The applications 600 themselves are communicatively coupled (e.g., via appropriate interfaces) to each other and to various data sources, so as to allow information to be passed between the applications or so as to allow the applications to share and access common data. The applications may furthermore access one or more databases via database servers (e.g., database server 724 of FIG. 7). Any one or all of the applications 600 may serve as a source of language-based communication for processing according to the methods described herein. The applications 600 may also serve as a source of passive and/or active user-generated information to augment the communication data.

In some embodiments, the applications 600 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the applications 600 may include a number of marketplace applications, such as at least one publication application 601 and one or more auction applications 602 which support auction-format listing and price setting mechanisms (e.g., English, Dutch, Vickrey, Chinese, Double, Reverse auctions etc.). The various auction applications 602 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 604 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 606 allow a seller to group listings within a “virtual” store, which may be branded and otherwise personalized by and for the seller. Such a virtual store may also offer promotions, incentives and features that are specific and personalized to a relevant seller.

Reputation applications 608 allow users that transact, perhaps utilizing a networked system, to establish, build and maintain reputations, which may be made available and published to potential trading partners. When, for example, a networked system supports person-to-person trading, users may otherwise have no history or other reference information whereby the trustworthiness and credibility of potential trading partners may be assessed. The reputation applications 608 allow a user, through feedback provided by other transaction partners, to establish a reputation within a networked system over time. Other potential trading partners may then reference such reputations for the purposes of assessing credibility and trustworthiness.

Personalization applications 610 allow users of networked systems to personalize various aspects of their interactions with the networked system. For example a user may, utilizing an appropriate personalization application 610, create a personalized reference page at which information regarding transactions to which the user is (or has been) a party may be viewed. Further, a personalization application 610 may enable a user to personalize listings and other aspects of their interactions with the networked system and other parties.

Marketplaces may be customized for specific geographic regions. Thus, one version of the applications 600 may be customized for the United Kingdom, whereas another version of the applications 600 may be customized for the United States. Each of these versions may operate as an independent marketplace, or may be customized (or internationalized) presentations of a common underlying marketplace. The applications 600 may accordingly include a number of internationalization applications 612 that customize information (and/or the presentation of information) by a networked system according to predetermined criteria (e.g., geographic, demographic or marketplace criteria). For example, the internationalization applications 612 may be used to support the customization of information for a number of regional websites that are operated by a networked system and that are accessible via respective web servers.

Navigation of a networked system may be facilitated by one or more navigation applications 614. For example, a search application (as an example of a navigation application) may enable key word searches of listings published via a networked system publication application 601. A browse application may allow users to browse various category, catalogue, or inventory data structures according to which listings may be classified within a networked system. Various other navigation applications may be provided to supplement the search and browsing applications.

In order to make listings available on a networked system as visually informing and attractive as possible, marketplace applications may operate to include one or more imaging applications 616 which users may use to upload images for inclusion within listings. An imaging application 616 can also operate to incorporate images within viewed listings. The imaging applications 616 may also support one or more promotional features, such as image galleries that are presented to potential buyers. For example, sellers may pay an additional fee to have an image included within a gallery of images for promoted items.

Listing creation applications 618 allow sellers conveniently to author listings pertaining to goods or services that they wish to transact via a networked system, and listing management applications 620 allow sellers to manage such listings. Specifically, where a particular seller has authored and/or published a large number of listings, the management of such listings may present a challenge. The listing management applications 620 provide a number of features (e.g., auto-relisting, inventory level monitors, etc.) to assist the seller in managing such listings. One or more post-listing management applications 622 can assist sellers with activities that typically occur post-listing. For example, upon completion of an auction facilitated by one or more auction applications 602, a seller may wish to leave feedback regarding a particular buyer. To this end, a post-listing management application 622 may provide an interface to one or more reputation applications 608, so as to allow the seller conveniently to provide feedback regarding multiple buyers to the reputation applications 608.

Dispute resolution applications 624 provide mechanisms whereby disputes arising between transacting parties may be resolved. For example, the dispute resolution applications 624 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 626 implement fraud detection and prevention mechanisms to reduce the occurrence of fraud within a networked system.

Messaging applications 628 are responsible for the generation and delivery of messages to users of a networked system, such messages for example advising users regarding the status of listings on the networked system (e.g., providing “outbid” notices to bidders during an auction process or to provide promotional and merchandising information to users). Respective messaging applications 628 may utilize any number of message delivery networks and platforms to deliver messages to users. For example, messaging applications 628 may deliver electronic mail (e-mail), instant message (IM), Short Message Service (SMS), text, facsimile, or voice (e.g., Voice over IP (VoIP)) messages via wired (e.g., Ethernet, Plain Old Telephone Service (POTS)), or wireless (e.g., mobile, cellular, WiFi, WiMAX) networks.

Merchandising applications 630 support various merchandising functions that are made available to sellers to enable sellers to increase sales via a networked system. The merchandising applications 630 also operate the various merchandising features that may be invoked by sellers, and may monitor and track the success of merchandising strategies employed by sellers.

A networked system itself, or one or more users that transact business via the networked system, may operate loyalty programs that are supported by one or more loyalty/promotions applications 632. For example, a buyer may earn loyalty or promotions points for each transaction established and/or concluded with a particular seller, and be offered a reward for which accumulated loyalty points can be redeemed.

FIG. 7 is a block diagram illustrating a client-server architecture to facilitate access to unstructured information according to various embodiments of the invention. The system 700 includes a client-server architecture that can be used to process unstructured information, including language-based communication, according to any of the methods described here. A platform, such as a network-based information management system 702, provides server-side functionality via a network 780 (e.g., the Internet) to one or more clients. FIG. 7 illustrates, for example, a web client 706 (e.g., a browser, such as the Internet Explorer browser developed by Microsoft Corporation of Redmond, Wash.), and a programmatic client 708 executing on respective client machines 710 and 712. In some embodiments, either or both of the web client 706 and programmatic client 708 may include a mobile device.

Turning specifically to the system 702, an Application Program Interface (API) server 714 and a web server 716 are coupled to, and provide programmatic and web interfaces respectively to, one or more application servers 718. The application servers 718 host one or more commerce applications 720 (e.g., similar to or identical to the applications 600 of FIG. 6) and unstructured information processing applications 722 (e.g., similar to or identical to the matching and processing modules 438, 440 of FIG. 4). The application servers 718 are, in turn, shown to be coupled to one or more database servers 724 that facilitate access to one or more databases 726, such as registries that include links between individuals, their profiles, their behavior patterns, user-generated information, topical ranks, and signatures.

Further, while the system 700 employs a client-server architecture, the various embodiments are of course not limited to such an architecture, and could equally well be applied in a distributed, or peer-to-peer, architecture system. The various applications 720 and 722 may also be implemented as standalone software programs, which do not necessarily have networking capabilities.

The web client 706, it will be appreciated, may access the various applications 720 and 722 via the web interface supported by the web server 716. Similarly, the programmatic client 708 accesses the various services and functions provided by the applications 720 and 722 via the programmatic interface provided by the application programming interface (API) server 714. The programmatic client 708 may, for example, comprise a matching module (e.g., similar to or identical to the matching module 438 of FIG. 4) to enable a user to submit requests and receive results based on matching signatures with respect to multiple sets of data, perhaps performing batch-mode communications between the programmatic client 708 and the network-based system 702. Client applications 732 and support applications 734 may perform similar or identical functions.

### Example Machine Architecture

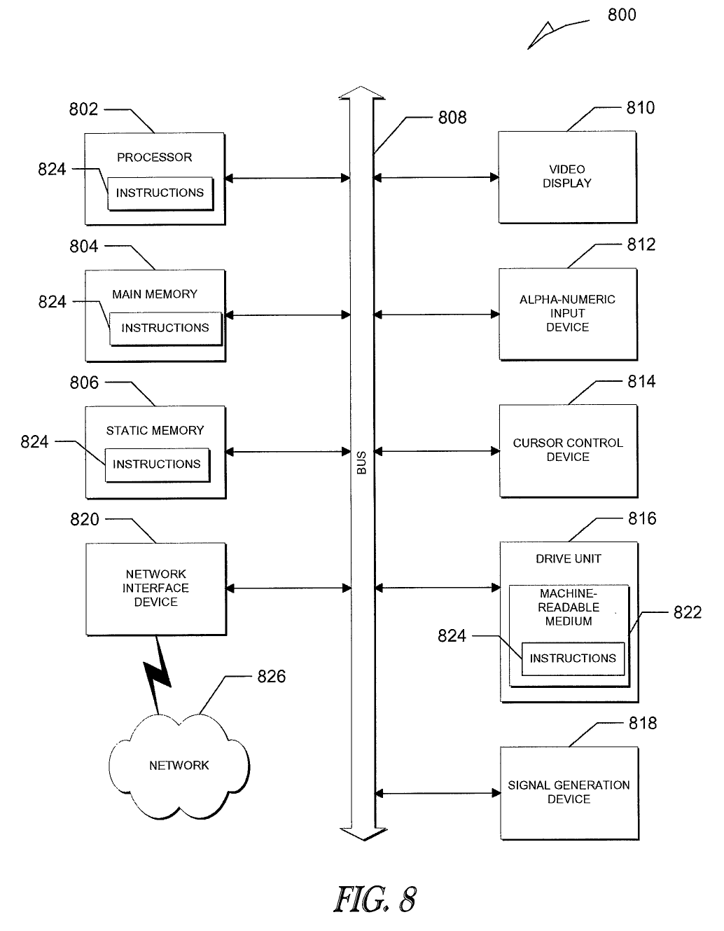

FIG. 8 is a block diagram of a machine 800 in the example form of a computer system according to various embodiments of the invention. The computer system may include a set of instructions for causing the machine to perform any one or more of the methodologies discussed herein. The machine 800 may also be similar to or identical to the terminal 402 or computer 430 of FIG. 4.

In alternative embodiments, the machine 800 may operate as a standalone device or may be connected (e.g., networked) to other machines. In a networked deployment, the machine 800 may operate in the capacity of a server or a client machine in a server-client network environment, or as a peer machine in a peer-to-peer (or distributed) network environment.

The machine 800 may comprise a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 may include a processor 802 (e.g., a central processing unit (CPU), a graphics processing unit (GPU) or both), a main memory 804 and a static memory 806, all of which communicate with each other via a bus 808. The computer system 800 may further include a video display unit 810 (e.g., liquid crystal displays (LCD) or cathode ray tube (CRT)). The display unit 810 may be used to display a GUI according to the embodiments described with respect to FIGS. 2 and 3. The computer system 800 also may include an alphanumeric input device 812 (e.g., a keyboard), a cursor control device 814 (e.g., a mouse), a disk drive unit 816, a signal generation device 818 (e.g., a speaker) and a network interface device 820.

The disk drive unit 816 may include a machine-readable medium 822 on which is stored one or more sets of instructions (e.g., software 824) embodying any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media. The software 824 may further be transmitted or received over a network 826 via the network interface device 820, which may comprise a wired and/or wireless interface device.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include tangible media that include, but are not limited to, solid-state memories, optical, and magnetic media.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information).

In conclusion, it can be seen that various embodiments of the invention can operate to combine a unique set of intuitive, empirical, and statistical analyses to arrive at a model that determines convergence characteristics of groups of unstructured information, including language-based communication. Using the apparatus, systems, and methods disclosed herein may improve computer user access to masses of unstructured data, providing more relevant search results, as well as other benefits, including increased user satisfaction.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method, comprising:
examining a first quantity of language-based communication to determine a plurality of topics associated with the first quantity of language-based communication; and
determining whether a number of the plurality of topics converge to a selected degree; and
responsive to determining that the number of the plurality of topics converge to the selected degree, ranking selected topics in the plurality of topics according to relevance.

2. The computer-implemented method of claim 1, wherein the language-based communication comprises:
at least one of online auction search queries, email messages, or conversation sound recordings.

3. The computer-implemented method of claim 1, wherein at least some of the plurality of topics comprise:
one of word portions, words, phrases, or parts of speech.

4. The computer-implemented method of claim 1, wherein the examining comprises:
parsing the quantity of language-based communication to assign at least one of word portions, words, phrases, or parts of speech as some of the plurality of topics.

5. The computer-implemented method of claim 1, wherein determining whether the number of the plurality of topics converge to a desired degree comprises:
determining that an occurrence frequency of at least one of the plurality of topics satisfies a selected occurrence boundary condition.

6. The computer-implemented method of claim 5, wherein the selected occurrence boundary condition is approached by the number of the plurality of topics approximately asymptotically.

7. The computer-implemented method of claim 1, wherein determining whether the number of the plurality of topics converge to a desired degree comprises:
determining that examining a second quantity of the language-based communication will not increase an occurrence frequency of at least one of the plurality of topics beyond a selected maximum occurrence frequency increment.

8. The computer-implemented method of claim 1, wherein determining whether the number of the plurality of topics converge to a desired degree comprises:
examining a second quantity of the language-based communication to determine additional topics; and
determining that an occurrence frequency associated with the additional topics is less than a selected maximum occurrence frequency.

9. The computer-implemented method of claim 1, comprising:
determining that at least one of the plurality of topics occurs with an occurrence frequency greater than a selected minimum frequency of occurrence.

10. The computer-implemented method of claim 1, comprising:
storing the ranking of the selected topics as a topical signature; and
associating the topical signature with the quantity of language-based communication.

11. The computer-implemented method of claim 10, comprising:
determining that an additional quantity of language-based communication has a new signature substantially matching the topical signature; and
retrieving some of the quantity of language-based communication based on the topical signature.

12. The computer-implemented method of claim 1, comprising:
examining an incoming email message to determine a message signature associated with topics included in the incoming email message; and
routing the incoming email message to a destination associated with the ranking of the selected topics associated with a topic signature substantially matching the message signature.

13. The computer-implemented method of claim 12, comprising:
sending a reply email message to an address associated with the incoming email message, wherein content of the reply email message is based on the topic signature.

14. The computer-implemented method of claim 1, comprising:
examining an incoming search query to determine a query signature associated with topics included in the incoming query; and
presenting one of a group of online auction items or an alternate search based on a topic signature substantially matching the query signature and associated with the ranking of the selected topics for the quantity of language-based communication comprising online auction description information or search entries, respectively.

15. The computer-implemented method of claim 1, comprising:
receiving a query to search the quantity of language-based communication;
retrieving a first portion of the quantity of language-based communication based on a query signature associated with the query substantially matching a topic signature associated with the ranking of the selected topics; and
either culling the first portion to provide a culled portion of the quantity of language-based communication or retrieving a second portion of the quantity of language-based communication based on user-generated relevancy information previously associated with the quantity of language-based information.

16. The computer-implemented method of claim 1, comprising:
receiving user-generated relevancy information associated with the quantity of language-based communication.

17. The computer-implemented method of claim 16, wherein the user-generated relevancy information comprises:
at least one of a rating, a tag, a hyperlink, a pre-defined item category, a sales price range, a brand, a role, a group, a portion of a user profile, a salary range, a name, or a comment.

18. The computer-implemented method of claim 16, comprising:
weighting retrieval of additional information based on the ranking of the selected topics according to the user-generated relevancy information.

19. A system, comprising:
a computer to communicatively couple to a global computer network; and
a matching module to examine user-supplied information received at the computer and to determine whether an information signature associated with the user-supplied information substantially matches a signature associated with ranking selected topics according to relevance, wherein the selected topics are selected from a plurality of topics associated with a quantity of language-based communication, and wherein a number of the plurality of topics have been previously determined to converge to a selected degree with respect to the quantity of language-based communication.

20. The system of claim 19, comprising:
a user terminal to couple to the computer and to present a graphical user interface to receive the user-supplied information.

21. The system of claim 19, comprising:
a storage device to couple to the computer and to store a database having the signature associated with ranking the selected topics and at least a portion of the quantity of language-based communication.

22. A machine-readable medium comprising instructions, which when executed by one or more processors, cause the one or more processors to perform the following operations:
examine a first quantity of language-based communication to determine a plurality of topics associated with the first quantity of language-based communication; and
determine whether a number of the plurality of topics converge to a selected degree; and
responsive to determining that the number of the plurality of topics converge to the selected degree, ranking selected topics in the plurality of topics according to relevance.

23. The machine-readable medium of claim 22, wherein the instructions, when executed by the one or more processors, cause the one or more processors to perform the following operations:
store a signature in a database associated with the selected topics and the first quantity of language-based data.

24. The machine-readable medium of claim 22, wherein the instructions, when executed by the one or more processors, cause the one or more processors to perform the following operations:
examine a second quantity of language-based communication to determine whether a number of a second set of topics associated with the second quantity of language-based communication converges to a substantially similar degree as the selected degree.

25. The machine-readable medium of claim 24, wherein the instructions, when executed by the one or more processors, cause the one or more processors to perform the following operations:
link user-generated relevancy information associated with the first quantity of language-based communication to the second quantity of language-based information.
